(19) United States
(12) Patent Application Publication
(10) Pub. No.: US 2004/0056129 A1
(43) Pub. Date: Mar. 25, 2004

(54) Beating arrangement

(76) Inventor: Werner Doppstadt, Velbert (DE)

Correspondence Address: WILLIAM COLLARD, COLLARD & ROE, P.C., 1077 NORTHERN BOULEVARD, ROSLYN, NY, 11576, US

(21) Appl. No.: 10/466,310

(22) PCT Filed: Jan. 8, 2002
(86) PCT No.: PCT/EP02/00100

(30) Foreign Application Priority Data
Jan. 13, 2001 (DE) 101 01 434.1

(51) Int. Cl. B02C 13/28

(52) U.S. Cl. 241/194; 241/195

(57) ABSTRACT

The invention relates to a beating arrangement for a rotary shredder, comprising a base body (12) which is rotationally arranged around an axis (20) and a cutting body (16) which is detachably fixed onto a protruding part (22) of the base body. A protruding profile (50) is formed on the front surface thereof in the direction of rotation whereon the cutting body (16) forms a positive fit. The profile (50) can be embodied in the form of a protruding truncated pyramid, whose base surface lies on the plane of cutting edges (30, 32) which are bilaterally symmetrical in relation to a surface which extends tangentially in relation to a circumference of rotation. The cutting body can be fixed by means of a screw (14), which extends through the centre of the cutting body and the profile.

### CROSS REFERENCE TO RELATED APPLICATIONS

Applicants claim priority under 35 U.S.C. §119 of GERMAN Application No. 101 01 434.1 filed on Jan. 13, 2001. Applicants also claim priority under 35 U.S.C. §365 of PCT/EP02/00100 filed on Jan. 8, 2002. The international application under PCT article 21(2) was not published in English.

### TECHNICAL FIELD

The invention relates to a flail mallet assembly for rotor shredders with a base body rotatably mounted about an axis and a cutting body releaseably fixed to a projection of the base body. Such flail mallets are used as striking tools for rotor shredders for, for example, plastic, wood or the like.

### STATE OF THE ART

From the DE 35 45 708 C2 a flail mallet assembly is known, wherein a cutting body shaped as a tooth is releaseably fixed with its shaft in a recess. The fixing is carried out by means of a screw extending through a bore hole in the base body and the shaft of the cutting body. The shaft is provided with a projecting edge at its end extending around a projection in the recess. Furthermore the shaft has a profile projecting into a complementary profile within the recess. Thereby the tooth is kept in its position even when strong forces occur. Usually the tip of the flail mallet is worn such that an edge is formed along the rotating movement direction of the flail mallet. Due to the complex shape of the described flail mallet assembly its production is difficult and expensive.

From the DE-OS 29 43 456 a device for shreddering of bark and annual plants is known. The device comprises a rotating body with a flail mallet arranged close to its circumference. Each flail mallet consists of a base body on one end pivotably arranged at the rotating body and of a cutting body fixed at the front surface, with respect to rotation, of the flail mallet. These cutting bodies are exchangeably fixed to the respective flail mallet bodies, as they suffer quick wear during operation of the assembly and can therefore be replaced without having to exchange the entire flail mallet.

With both arrangements comparatively much material, i.e. the entire cutting body, is rendered useless if the tip of the flail mallet is exchanged.

### DISCLOSURE OF THE INVENTION

It is the object of the invention to provide a flail mallet assembly with an easily replaceable cutting body using as little material as possible. It is a further object of the invention to provide a flail mallet assembly which can easily produced. It is yet another object of the invention to provide a flail mallet assembly with a good transmission of forces to the base body.

According to the invention these objects are achieved by a flail mallet assembly according to the first portion of claim 1, the flail mallet assembly being provided with a projecting profile at the in the direction of the rotation front surface of the projection, to which the cutting body is form-fitted. Thereby an optimal transmission of the forces is achieved by form-fitting. The material which shall be cut usually generate great forces in different directions of the cutting body and through the cutting body to the base body of the flail mallet assembly. By transmitting the forces by form-fitting, not only forces perpendicular to the direction of movement of the cutting body can be taken up, but also all other active forces of the cutting material to the flail mallet. No extensive strain on fixing devices, such as by screws and the like occurs.

The profile at the base body corresponds to the profile at the cutting body, for example a recess. Thereby the cutting body has a smaller volume with the respective smaller material consumption.

In a preferred embodiment of the invention the profile has the form of a projecting truncated pyramid, its base area laying in the plane of the front surface of the projection. This form is easy to manufacture and suitably reduces the material consumption. With the amount of sides of the truncated pyramid the amount of positions is set, in which the cutting body can be fixed. Thereby an adjusting position of the cutting edge is not necessary.

Preferably the cutting body is provided with two cutting edges symmetrical two a plane running tangential to a rotational circumference. However, there can be a plurality of cutting edges, also. For a four-sided truncated pyramid four cutting edges are possible. If the truncated pyramid has more sides the amount of cutting edges can be increased. In this embodiment the cutting body can be used several times. The cutting body only has to be loosened and turned by an angle set by the geometry and fixed again. Thereby the material consumption and the required time are further reduced.

In a further embodiment of the invention the cutting body is screwed by means of a screw running through the middle of the cutting body and through the profile. There are further ways of fixing, especially because the side forces are not taken up by the screw anymore but by the profile. The base body preferably has a recess at the in the direction of the rotation rear surface of the projection, wherein the nut for the screw can be embedded. Thereby the strain and damaging of the nut is avoided. Furhtermore the required length of the screw is shortened. Furthermore the cutting body can be provided with a recess at the in the direction of the rotation front surface, wherein the head of the screw can be embedded at least partially. Thereby less strain and damaging of the head of the screw is effected.

In order to achieve an optimal cutting effect with small damaging and wear of the base body the surface of the cutting body preferably being chamfered at the side opposite to the axis of rotation. This one is aligned with the chamfered side of the base body opposite to the axis of rotation, when the cutting body is fixed to the base body. Thereby the wear of the base body is minimized.

The cutting edge of the cutting body preferably is hardened to ensure a long lifetime.

Further embodiments of the invention are subject matter of the subclaims. An example is described below in greater detail with reference to the accompanying drawings.

### BRIEF DESCRIPTION OF THE DRAWINGS

FIG. 1 shows a perspective view of a rotor flail mallet with a base body and a cutting body screwed onto it.

FIG. 2 shows a perspective view of the rotor flail mallet of FIG. 1 without the cutting body.

FIG. 3 shows a cut view through the rotor flail mallet of FIG. 1.

### DESCRIPTION OF AN EMBODIMENT

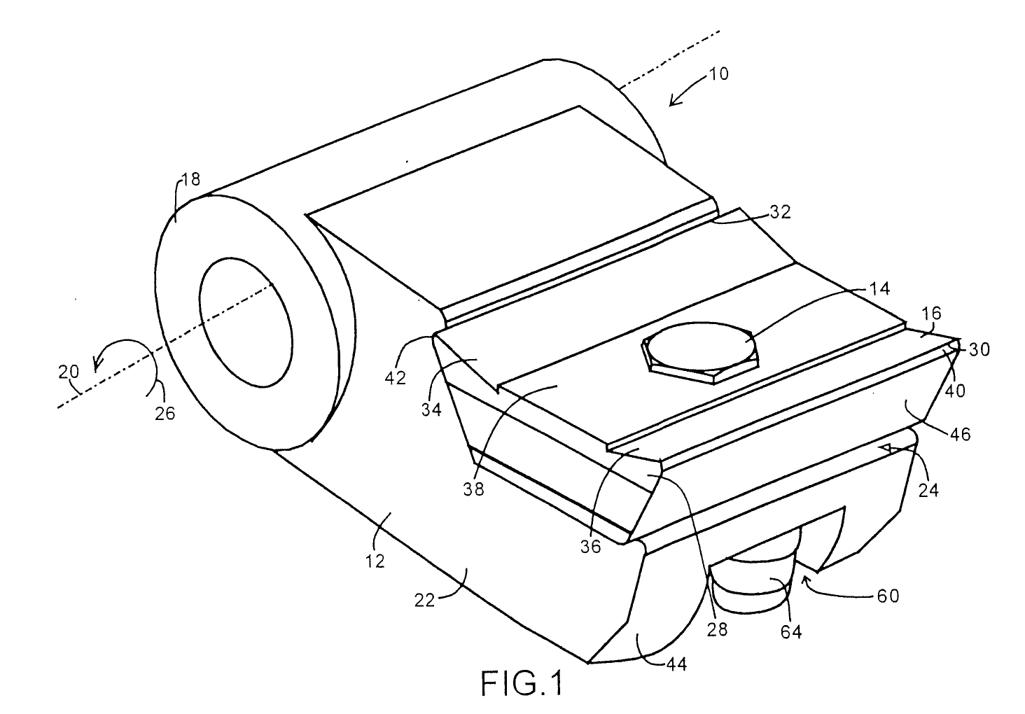

In FIG. 1, 10 denotes a rotor flail mallet. The rotor flail mallet 10 comprises a base body 12 and a cutting body 16 screwed onto it with a screw 14, which forms the tip of the flail mallet. The base body 12 consists of a hollow cylinder 18 being rotatably mounted about an axis 20. A projection 22 is provided at the hollow cylinder. The projection 22 is shaped essentially with a step, wherein the “step” has a surface 24 on which the cutting body 16 lies. The surface 24 is directed in the direction of the rotational movement represented by an arrow 26 in FIG. 1. It, therefore, forms the front surface of the base body 12. The cutting body 16 lies in a fitted manner on the base body 12. Due to the step-like arrangement the cutting body 16 is surrounded on two sides by the base body 12 and forms a unit therewith, where cutting material cannot enter into.

The cutting body 16 has a uniform trapezoid cross section over its entire width. The smaller parallel surface 26 of the trapezoid forms the rear side of the cutting body 16 adjacent to the front surface 24 of the base body 12. The front portion 28 of the cutting body 16 is hardened. Thereby the wear of the cutting edges is delayed. The cutting body can also consist of two portions, a hardened front portion and a non-hardened back portion being connected with each other.

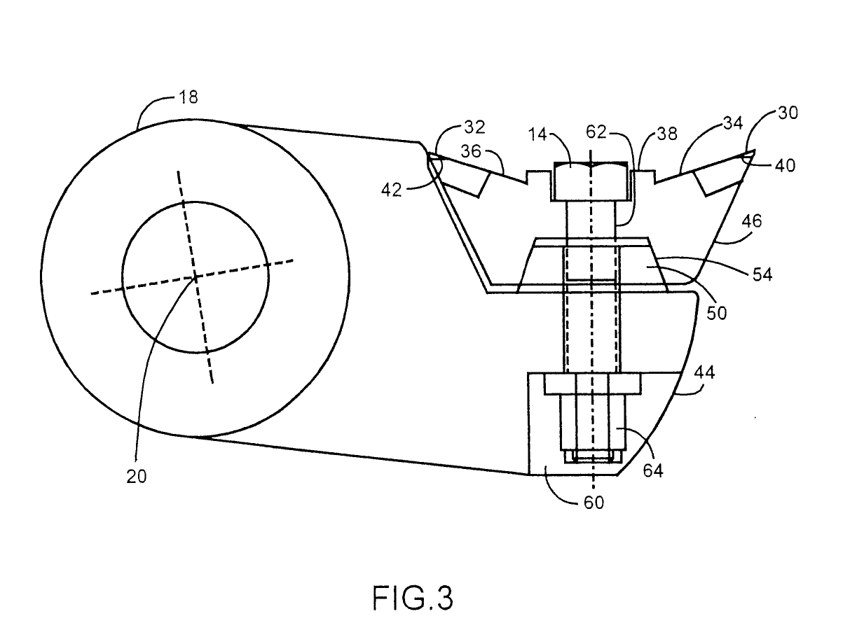

The front portion 28 of the cutting body comprises two cutting edges 30 and 32, parallel to each other on opposite sides of the cutting body. In different embodiments four cutting edges can be provided on each side of the cutting body at an angle of about 90 degrees. The cutting edges 30 and 32 are slightly projecting. Accordingly the surface 34 or 36, respectively runs a little inclined towards the edges. Thereby an optimal cutting effect is achieved. In order to achieve a good stability the middle portion 38 of the front surface between the cutting edges 30 and 32 is straight, i.e. parallel with respect to the rear surface 26 of the cutting body. The angle of the cross-sectional trapezoid is truncated somewhat at its ends 40 and 42. This is shown in FIG. 3 also.

The rear surface of the base body 12 and the surface 44 opposite to the axis are not exactly plane. Thereby the resistance with respect to the cutting material is smaller. The surface 44 opposite to the axis extends such that it joins the side surface 46 of the cutting body 16 without edges.

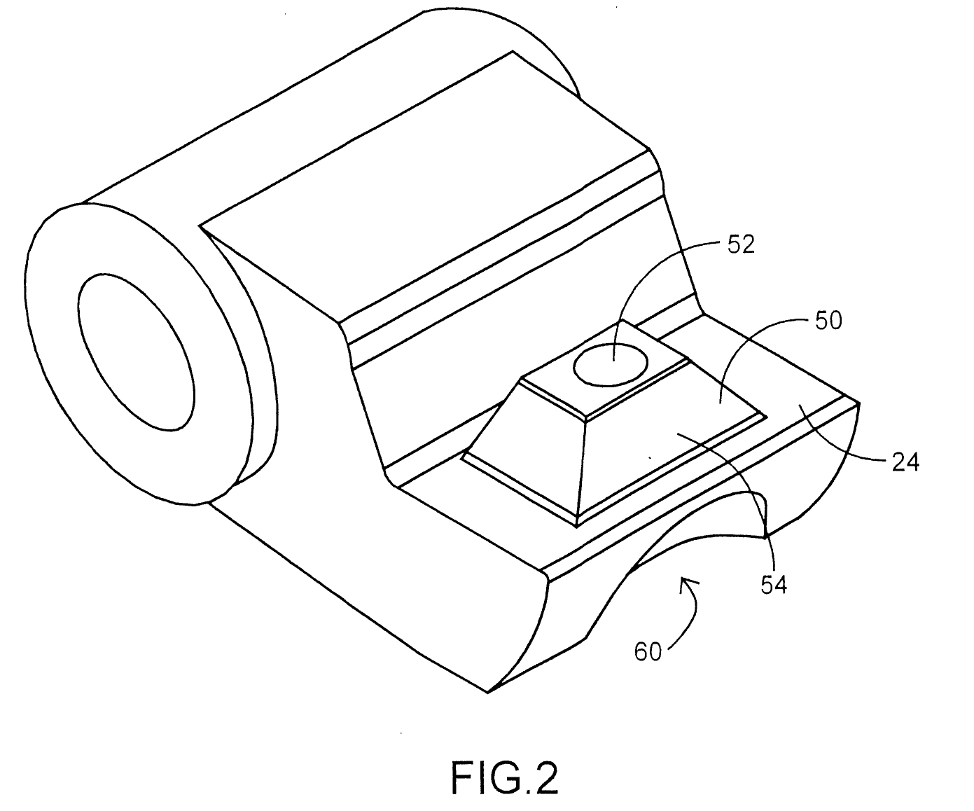

In FIG. 2 the base body 12 is shown without the cutting body. At the front surface 24 of the base body 12 a profile 50 in the form of a truncated pyramid can be seen. Within the truncated pyramid 50 a bore hole 52 is provided for the screw 14. The sides 54 have a relative angle of 90 degrees and two sides have edges parallel to the cutting angles 30, 32 (FIG. 3).

The cutting body 16 has a recess on its back side which is complementary to the profile 50. By this arrangement the cutting body 16 can only be screwed on or otherwise fixed in four different positions on the base body. An adjustment is not necessary. In the present case the cutting body 16 is fixed in such a way that the two cutting edges 30, 32 extend parallel to the axis 20 of rotation of the flail mallet. If the cutting edge used up the screw 14 is loosende, the cutting body is rotated by an angle of 180 degrees and the screw is fixed again. The “fresh” cutting edge then sits at the position of the previous one. If cutting edges are provided at each side of the cutting body 16 the cutting body can be used four times instead of two times. If further cutting edges shall be provided the amount of sides of the truncated pyramid 50 has to be increased.

A recess 60 is provided on the rear side of the base body 12. The screw 14 extends through a bore hole 62 in the cutting body 16 and the bore hole 52 in the base body. A fitting nut 64 for the screw 14 is arranged in the recess 60. Thereby the bore holes 52 and 62 do not need to be threaded which of course is also possible. Due to the protected position of the head of the screw and the nut they are not or only little affected by the cutting material.

1. Flail mallet assembly for rotor shredders with a base body rotatably mounted about an axis and a cutting body releaseably fixed to a projection of the base body characterized in that the flail mallet assembly is provided with a projecting profile at the in the direction of the rotation front surface of the projection, to which the cutting body is form-fitted.

2. Flail mallet assembly according to claim 1, characterized in that the profile has the form of a projecting truncated pyramid, its base area laying in the plane of the front surface of the projection.

3. Flail mallet assembly according to claim 1 or 2, characterized in that the cutting body is provided with two cutting edges symmetrical to a plane extending tangential to a rotational circumference.

4. Flail mallet assembly according to one of the preceeding claims, characterized in that the cutting body is screwed by means of a screw extending through the middle of the cutting body and through the profile.

5. Flail mallet assembly according to claim 4, characterized in that the base body has a recess at the in the direction of the rear surface, with respect to the rotation, of the projection, wherein a nut for the screw can be embedded.

6. Flail mallet assembly according to claim 4, characterized in that the cutting body is provided with a recess at the in the direction of the front surface, with respect to the rotation, wherein the head of the screw can be embedded.

7. Flail mallet assembly according to one of the preceeding claims, characterized in that the surface of the cutting body is chamfered at the side opposite to the axis of rotation and is aligned with the chamfered side of the base body opposite to the axis of rotation, when the cutting body is fixed to the base body.

8. Flail mallet assembly according to one of the preceeding claims, characterized in that the cutting edge of the cutting body is hardened.
